(19) United States
(12) Patent Application Publication
(10) Pub. No.: US 2009/0142845 A1
(43) Pub. Date: Jun. 4, 2009

(54) FLOW REACTOR METHOD AND APPARATUS

(75) Inventors: Otman Benali, Essex (GB); Martyn John Deal, Essex (GB); Coulton Heath Legge, Hertfordshire (GB); Robert Charles Wheeler, Hertfordshire (GB); Rodrigo Zapiain Bazdresch, Essex (GB)

Correspondence Address: GLAXOSMITHKLINE;CORPORATE INTELLECTUAL PROPERTY, MAI B482, FIVE MOORE DR., PO BOX 13398, RESEARCH TRIANGLE PARK, NC, 27709-3398, US

(73) Assignee: SmithKline Beecham Corporation

(21) Appl. No.: 12/063,254

(22) PCT Filed: Aug. 10, 2006
(86) PCT No.: PCT/US06/31169

§ 371 Date: Apr. 14, 2008

Related U.S. Application Data
(60) Provisional application No. 60/707,233, filed on Aug. 11, 2005.

(51) Int. Cl. G01N 31/00; B01J 19/00; G01N 21/00

(52) U.S. Cl. 436/8; 422/68.1; 422/82.05; 422/63

(57) ABSTRACT

A method of conducting a chemical reaction in a flow reactor comprises the steps of pumping at least one liquid reaction plug bounded at both ends by liquid spacer plugs along a reaction channel of the reactor; and conducting the chemical reaction in the reaction plug inside the reaction channel, wherein the liquid reaction plug comprises one or more reagents dispersed in a reaction solvent, the liquid spacer plugs are immiscible in the reaction solvent, and the reagents are substantially insoluble in the spacer plugs; and wherein the aspect ratio of the at least one reaction plug is at least about 10.

### CROSS-REFERENCE TO RELATED APPLICATIONS

This application claims the benefit of U.S. Patent Application Ser. No. 60/707,233, filed Aug. 11, 2005, the disclosure of which is incorporated herein by reference in its entirety. The disclosures of the following U.S. Provisional Applications, commonly owned and simultaneously filed Aug. 11, 2005, are all incorporated by reference in their entirety: U.S. Provisional Application entitled MICROFLUIDIC APPARATUS AND METHOD FOR SAMPLE PREPARATION AND ANALYSIS, U.S. Provisional Application No. 60/707,373 (Attorney Docket No. 447/99/2/1); U.S. Provisional Application entitled APPARATUS AND METHOD FOR HANDLING FLUIDS AT NANO-SCALE RATES, U.S. Provisional Application No. 60/707,421 (Attorney Docket No. 447/99/2/2); U.S. Provisional Application entitled MICROFLUIDIC BASED APPARATUS AND METHOD FOR THERMAL REGULATION AND NOISE REDUCTION, U.S. Provisional Application No. 60/707,330 (Attorney Docket No. 447/99/2/3); U.S. Provisional Application entitled MICROFLUIDIC METHODS AND APPARATUSES FOR FLUID MIXING AND VALVING, U.S. Provisional Application No. 60/707,329 (Attorney Docket No. 447/99/2/4); U.S. Provisional Application entitled METHODS AND APPARATUSES FOR GENERATING A SEAL BETWEEN A CONDUIT AND A RESERVOIR WELL, U.S. Provisional Application No. 60/707,286 (Attorney Docket No. 447/9912/5); U.S. Provisional Application entitled MICROFLUIDIC SYSTEMS, DEVICES AND METHODS FOR REDUCING DIFFUSION AND COMPLIANCE EFFECTS AT A FLUID MIXING REGION, U.S. Provisional Application No. 60/707,220 (Attorney Docket No. 447/99/3/1); U.S. Provisional Application entitled MICROFLUIDIC SYSTEMS, DEVICES AND METHODS FOR REDUCING NOISE GENERATED BY MECHANICAL INSTABILITIES, U.S. Provisional Application No. 60/707,245 (Attorney Docket No. 447/99/3/2); U.S. Provisional Application entitled MICROFLUIDIC SYSTEMS, DEVICES AND METHODS FOR REDUCING BACKGROUND AUTOFLUORESCENCE AND THE EFFECTS THEREOF, U.S. Provisional Application No. 60/707,386 (Attorney Docket No. 447/99/3/3); U.S. Provisional Application entitled MICROFLUIDIC CHIP APPARATUSES, SYSTEMS, AND METHODS HAVING FLUIDIC AND FIBER OPTIC INTERCONNECTIONS, U.S. Provisional Application No. 60/707,246 (Attorney Docket No. 447/99/4/2); U.S. Provisional Application entitled METHODS FOR CHARACTERIZING BIOLOGICAL MOLECULE MODULATORS, U.S. Provisional Application No. 60/707,328 (Attorney Docket No. 447/99/5/1); U.S. Provisional Application entitled METHODS FOR MEASURING BIOCHEMICAL REACTIONS, U.S. Provisional Application No. 60/707,370 (Attorney Docket No. 447/99/5/2); and U.S. Provisional Application entitled METHODS AND APPARATUSES FOR REDUCING EFFECTS OF MOLECULE ADSORPTION WITHIN MICROFLUIDIC CHANNELS, U.S. Provisional Application No. 60/707,366 (Attorney Docket No. 447/99/8); U.S. Provisional Application entitled PLASTIC SURFACES AND APPARATUSES FOR REDUCED ADSORPTION OF SOLUTES AND METHODS OF PREPARING THE SAME, U.S. Provisional Application No. 60/707,288 (Attorney Docket No. 447/99/9); U.S. Provisional Application entitled BIOCHEMICAL ASSAY METHODS, U.S. Provisional Application No. 60/707,374 (Attorney Docket No. 447/99/10); and U.S. Provisional Application entitled MICROFLUIDIC SYSTEM AND METHODS, U.S. Provisional Application No. 60/707,384 (Attorney Docket No. 447/99/12).

### TECHNICAL FIELD

The present disclosure relates to a method of conducting a chemical reaction or sequential series of chemical reactions in pressure driven flow reactors. The present disclosure also relates to flow reactors specifically adapted for carrying out the inventive methods.

### BACKGROUND ART

Flow reactors have distinct advantages over batch reactors in terms of scalability, safety and control of the reaction conditions. Flow reactors are essentially pipes. Reagent plugs in a spacer solvent enter at one end and flow down the ‘pipe’, reacting as they flow. The reaction products then emerge at the far end of the system. Although flow reactor performance can be satisfactory on a small scale, when the scale is increased plug dispersion results in significant dilution effects. These dilution effects lead to differing concentration gradients and a wide distribution of reactor residence times.

U.S. Pat. No. 6,458,335 describes a flow reactor for carrying out controlled precipitation reactions, for example of metal oxalates. Small aqueous reaction plugs in the reactor are separated by gas bubbles, or by plugs of immiscible solvents, in order to control plug dispersion. The process is said to improve homogeneity and reproducibility of the precipitate formation. The aqueous plugs are small, typically having an aspect ratio (i.e. ratio of length to diameter) in the range of 2 to 3.

PCT International Patent No. WO 2004/038363 discloses a process for operating a microreactor comprising an etched reaction channel having diameter 0.2 mm or less. The process comprises pumping a water-immiscible solvent (such as a fluorinated oil) through the channel, and injecting spaced reaction plugs of an aqueous reaction mixture into the flow of solvent to form spaced sequential reaction plugs. The reaction plugs have small volumes, typically femtolitres to nanolitres. The reaction plugs have an aspect ratio of from 1 to 4 in order to ensure homogeneity of the plugs on the micro scale.

The Publication Journal of Combinatorial Chemistry, 2005, 7(1), pages 14-20 discloses a microcoil NMR probe for performing NMR on a series of small samples. Plugs containing the samples in a suitable solvent, typically CDCl₃, d₆-DMSO or another NMR compatible solvent, are introduced into a capillary tube of internal diameter 0.1 mm and caused to flow past the NMR probe. The sample plugs are spaced apart by plugs of an inert immiscible solvent. The spacer plugs between the sample plugs may also contain an embedded wash plug of immiscible organic solvent. Each discrete plug is typically 1 to 10 μL. The flow rate in the transfer line during flow cycles is typically 1 to 20 μL/min. No chemical reactions take place in the plugs.

There is a need to provide improved methods and apparatus for carrying out chemical reactions in flow reactors.

### SUMMARY

The subject matter disclosed herein relates to carrying out chemical reactions in flow reactors by introducing the reagents (dispersed in a reaction solvent) as a series of long reaction plugs separated by inert and immiscible liquid spacers. The present inventors have found that excellent homogeneity and reproducibility can be obtained with reaction plugs having aspect ratios of 10 or more. Without wishing to be bound by any theory, it is thought that pressure driven flow of the plugs causes circulation of liquid within the plugs that maintains chemical homogeneity of the plugs. The use of long reaction plugs provides increased throughput of the reactor and easier separation of the products, together with other advantages.

Accordingly, in a first aspect, the subject matter disclosed herein provides a method of conducting a chemical reaction in a flow reactor, said method comprising the steps of: pumping at least one liquid reaction plug bounded at both ends by liquid spacer plugs along a reaction channel of said reactor; and conducting said chemical reaction in said reaction plug inside said reaction channel, wherein the liquid reaction plug comprises one or more reagents dispersed in a reaction solvent, the liquid spacer plugs are immiscible in the reaction solvent, and the reagents are substantially insoluble in the spacer plugs; and wherein the aspect ratio of the at least one reaction plug is at least about 10.

Many aspects of the method of the subject matter disclosed herein have an impact on the integrity of the plug. These include but are not limited to: the channel material; the composition of the spacer solvent; the composition of the reaction solvent; the flow rate; and the internal diameter of the channel.

The principal desired properties of the spacer solvent are that it has a very low miscibility with the reaction components and the reaction solvent, and that it preferentially wets the inner surface of the channel. That is to say, the spacer solvent has higher affinity (lower interfacial free energy) for the inner surface of the channel than the reaction solvent. This results in a reaction plug that has a convex meniscus at its ends. Furthermore, the spacer solvent then forms a thin film layer on the inside of the reaction channel that prevents the reaction solvent from wetting the surface and thereby reduces adsorption and dispersion of reaction components due to such adsorption and further, aids transportation of suspended solids dispersed within the reagent or reaction plug, along the tube and reduces the risk of particle aggregation leading to blockages in the process line.

Suitably, the spacer solvents are fluorinated solvents (also referred to herein as fluorous solvents), preferably perfluorinated solvents, for example perfluoroalkanes. The inert spacer used in the subject matter disclosed herein is, preferably, perfluorodecalin, but when controlled temperatures outside the range 20 to 80° C. are used the spacer solvent is more preferably perfluoro(methyldecalin).

The immiscibility of fluorous solvents is due to their low polarisability, high ionisation potential and electronegativity of fluorine. These characteristics give rise to weak intermolecular (Van der Waals) forces that result in the low boiling points typically associated with fluorous solvents. Fluorocarbon solvents typically possess high densities (2.5 times those of their hydrocarbon analogues), have low dielectric constants and a lower polarity than saturated hydrocarbon alkanes. This is due to the low surface potential and the compact electron distribution of these fluorocarbon solvents

Suitably, the reaction solvents are organic solvents, preferably dimethylformamide (DMF), dimethylsulfoxide (DMSO), N-methyl pyrrolidinone (NMP), acetonitrile, dichloromethane (DCM), chloroform, ethyl acetate, ethanol, methanol, tetrahydrofuran (THF), diethyl ether, toluene, or mixtures thereof.

In certain embodiments, the choice of solvents may be reversed so that a fluorous solvent is used as the reaction solvent. It has been found that fluorinated solvents preferentially solubilise reagents or reaction products when they have been tagged with a highly fluorinated molecule. This allows materials to be selectively contained within either the organic plug or the spacer plug, or allowed to pass by design from one phase or the other. This produces a favourable scenario, as the pure reaction product can be isolated by design in either the reaction plug or the spacer plug This methodology relies on the very low miscibility of fluorous solvents with aqueous and most organic solvents.

In certain embodiments, the flow reactor comprises first and second inlet channels that meet at an inlet of the reaction channel, and the method comprises: pumping a first reagent liquid plug containing a first reagent and bounded at both ends by liquid spacer plugs along the first inlet channel,

pumping a second reagent liquid plug containing a second reagent and bounded at both ends by liquid spacer plugs along the second inlet channel said pumping being carried out such that said first reagent plug mixes with said second reagent plug in said reaction channel to form said reaction plug containing a reaction mixture.

In further embodiments, the flow reactor comprises a further inlet channel in fluid communication with the reaction channel, and the method comprises: pumping a further reagent liquid plug containing a further reagent and bounded at both ends by liquid spacer plugs along the further inlet channel; said pumping being carried out such that said further reagent plug mixes with said reaction plug in said reaction channel. These embodiments are suitable for sequential or simultaneous addition of two, three or more reagents. These methods of the subject matter disclosed herein permit precisely controlled stoichiometric mixing of the reagent solutions by selection of plug sizes and pumping rates. These methods of the subject matter disclosed herein permit reagent solutions to be stored and manipulated in stable form, with mixing of reagents taking place only in the small-diameter reaction channel. This gives a number of advantages in terms of scalability and safety.

The flow reactor of the subject matter disclosed herein is typically made with channels that are between about 0.25 to about 2.00 mm in diameter, for example from about 0.5 mm to about 1.2 mm in diameter, and each reaction channel is typically from about 0.1 m to about 100 m in length. The device typically comprises two inlet channels that meet at a junction, which allows the reagents to be introduced into a flowing stream of immiscible spacer solvent separately. However, the device may contain more than two channels depending on the type of reaction that is being conducted. The reagent plugs are mixed under laminar flow conditions when the channels, carrying the reagents encapsulated by the immiscible solvent, intersect at a T-junction to form a single channel.

The chemical reaction in the reaction plug may be initiated solely by mixing with a second or further reagent as described above. Alternatively or additionally, the step of initiating a chemical reaction in the reaction plug comprises application of heat, pressure, microwave radiation, light, or ultrasound to the reaction plug or reagent plug. In an embodiment of the subject matter disclosed herein, the flow reactor comprises a means of heating the reaction plugs after they meet in the reaction channel. A heater allows the temperature of the reaction plugs to be discretely controlled. Alternatively or additionally, the temperature of the reaction plug may be controlled by cooling, to control excess heat generated from the reaction plug, or to slow the reaction kinetics to allow a controlled reaction. In a further embodiment of the subject matter disclosed herein, the flow reactor comprises a means of cooling the reagent plugs before they meet in the reaction channel, and the reaction plug in the reaction channel. It also gives the opportunity to obtain more in-depth data pertaining to reactions and their kinetics. In certain embodiments, a microwave heater is used, which causes the temperature of organic solvents to rise in preference to that of the fluorous solvents.

In certain embodiments, the methods of the subject matter disclosed herein further comprise monitoring the reaction taking place inside the channel by means of a detector, or by chemical analysis of samples drawn from the channel. The results from such monitoring can be used to provide integrated intelligent feedback to control and optimise the conditions and components of subsequent reagent and reaction plugs. Integrated intelligent feedback can allow the whole process to be fully automated and, thus, give more accurate control over the whole sequence. Such integrated intelligent feedback is disclosed in PCT International patent application no. WO-A-2004/089533 and UK patent application No. 0422378.0, the contents of which are hereby incorporated herein by reference.

In certain embodiments, the methods of the subject matter disclosed herein further comprise monitoring the passage of the reaction and/or spacer plugs through the channel by means of one or more plug detectors.

For example, a plug detector may be located near a downstream end (outlet) of the reaction channel, and the method may further comprise switching the outlet of said channel between a reaction mixture collector and a spacer solvent collector in response to an output of the plug detector.

Alternatively or additionally, one or more plug detectors may be located adjacent to a junction between a reagent inlet channel and the reaction channel, and pumping of the reagent plugs may then be carried out in response to the output of the plug detector(s) such that the further reagent plugs flow into the reaction channel synchronously with the passage of a first reaction plug past said junction, to form a combined reaction plug containing a reaction mixture.

Alternatively or additionally, one or more detectors may be located near a downstream end (outlet) of the reaction channel, and switching of a valve incorporated into the reaction channel may then be carried out in response to the output of the plug detector(s) such that a small portion of the reaction plug can be diverted to a parallel system for chemical analysis as a representative sample of the whole reaction plug.

Suitably, the pumping flow rate in the reaction channel of the flow reactor according to the subject matter disclosed herein is from about 0.05 ml/min to about 2 ml/min, preferably from about 0.1 ml/min to about 1 ml/min.

Suitably, the aspect ratio of the reaction plug is at least about 50, preferably at least about 500, and more suitably at least about 1000. Aspect ratios up to and greater than 10,000 have been shown to be satisfactory. Suitably, the volume of the reaction plugs is at least about 0.05 ml, preferably at least about 0.5 ml, more preferably at least about 5 ml.

Suitably, the volume of said spacer solvent between reaction plugs is from about 0.2 ml to about 1 ml. Suitably, the ratio of reaction solvent to spacer solvent used in the method of the subject matter disclosed herein (by volume) is from about 2 to about 1000, preferably from about 5 to about 200, more preferably from about 10 to about 100. These relatively high ratios provide for economy of spacer solvent usage, higher throughput, and easier work-up of the reaction mixture.

In certain embodiments, the methods according to the subject matter disclosed herein further comprise the step of embedding a wash plug of a wash solvent that is immiscible in the spacer solvent in at least one of the spacer solvent plugs. The wash solvent is usually of similar type to the reaction solvent, and preferably it is the same as the reaction solvent. The wash plug is bounded on both sides by plugs of the spacer solvent.

Suitably at least one of the reagent plugs is formed by the steps of: filling or part filling a sample loop with the reagent solution; pumping the spacer solvent into an inlet channel of the flow reactor; followed by displacing the reagent solution from the sample loop into the said inlet channel by pumping the spacer solvent into said sample loop.

The term “sample loop” refers to any liquid reservoir of suitable size to hold at least one plug-volume of the reaction solvent. The term “sample loop” is used because a convenient format for such a reservoir is a loop of the tubing used to make the reaction channel. The use of a sample loop conveniently permits reaction plugs of any predetermined size to be made for injection into the channels.

In certain of these embodiments, the sample loop is filled through a reagent inlet line from a reagent solution reservoir, and the method further comprises back-flushing said reagent inlet line with further spacer solvent after said step of filling.

It has been found that a single sample loop of convenient size may not be suitable for injecting very long reaction plugs, for example, increasing the sample loop size increases pressures induced in the loop, adversely affecting the plug integrity, or decreasing the speed of filling. Accordingly, the present inventors have devised an improved injector for providing reaction plugs of indefinite length to the flow reactor. In these embodiments, at least one of the reagent plugs is formed by the steps of: filling a first sample loop with the reaction solution; pumping the reaction solution from the first sample loop into an inlet channel by means of displacing it by pumped spacer solvent, while filling a second sample loop with the reaction solution; followed by pumping the reaction solution from the second sample loop into the inlet channel by displacement with a pumped spacer solvent, while refilling the first sample loop with the reaction solution.

In a second aspect, the subject matter disclosed herein provides an apparatus specifically adapted for performing a method according to the subject matter disclosed herein. Suitably, the apparatus comprises: a flow channel having a cross sectional area of at least about 0.05 mm² and length at least about 50 cm; a first reservoir for a reaction solvent containing a reagent; a sample loop for containing a sufficient quantity of the reaction solvent to provide a reaction plug in said flow channel having an aspect ratio of at least about 10; a second reservoir for a spacer solvent that is immiscible in the reaction solvent; and at least one pump for pumping said first and spacer solvents through said channel.

The channel is normally tubular, and preferably in the form of an elongate tube. The internal cross-section of the tube is preferably circular. The cross-sectional area of the channel is preferably from about 0.1 mm² to about 4 mm², and the length of the channel is from about 1 m to about 50 m. This permits the methods of the subject matter disclosed herein to be used in conventional meso-scale flow reactor systems.

The channel preferably has an inside surface that is compatible (i.e. is preferentially wetted by) the spacer solvent. The inside surface may suitably be hydrophobic. The inside surface is preferably compatible with fluorinated solvents, for example the inside surface may comprise a fluorinated material. For example, the channel may be made from a fluoropolymer or the inside surface may be treated with a fluorinated material. Suitably, the channel is manufactured from a polytetrafluoroethylene (PTFE) or a perfluoroalkoxy resin (PFA).

The principal properties of the channel walls are that they should be compatible with the fluorous solvent spacer due to minimal interfacial energy, but incompatible with the reagents and reactants due to high interfacial energy.

Preferably, the subject matter disclosed herein uses channels having hydrophobic inner surfaces. These hydrophobic channels are, typically, perfluoropolymer channels, and can be selected for example from polytetrafluoroethylene (PTFE) and low, medium and, high grade PFA. The interfacial energy between the fluorous spacer solvent and such a channel is considerably lower than that of the reagents plug and the channel. As a result the spacer solvent will coat or ‘wet’ the channel wall, thus, eliminating the interaction of reagents or reactants with the channel wall.

Hydrophilic channels such as glass channels can be treated with a suitable fluorinated or hydrophobic moiety to render their inner surfaces fluorocarbon-compatible and/or hydrophobic. A chemical treatment may involve the reaction of a fluorous moiety or fluoropolymer, for example a fluoro-alkyl chloride, with the silanol groups on the surface of the glass channel. This treatment prevents contamination of the channel wall with either reagents or reactants. Suitable hydrophobic finishes that can be applied to these hydrophilic channels include fluorinated silanes, such as perfluoroalkylsilane, long chain alkyl silanes, such as hexyl or octyl silane, or mono- and di-chlorinated silanes, such as decyldichlorosilane.

The apparatus according to the subject matter disclosed herein is preferably adapted for mixing of two or more reagents in a reaction channel. In these embodiments, the apparatus further comprises: a second channel in fluid communication with the reaction channel at a junction; a third reservoir containing a third solvent that may be the same or different to the first reaction solvent, that is miscible with the reaction solvent and a second reagent dispersed in the third solvent; and wherein the at least one pump is suitable for pumping said first and spacer solvents alternately through said second channel and into said reaction channel at said junction to form mixed plugs of said first and second reagents in said reaction channel.

The sample loop enables predetermined amounts of the reaction solvent to be injected into the reaction channel. Preferably, the first and second reservoirs, an inlet of the reaction channel, and inlet and outlet ends of the sample loop are connected through respective liquid conduits to a multi-port valve. The multi-port valve can suitably be switched between a first state for filling the sample loop and a second state for injecting the contents of the sample loop into the reaction channel.

The spacer and reagent plugs are pumped through the channels under hydrodynamic pumping conditions by a suitablye pump, which can be, for example, a pump of the type used for high performance liquid chromatography (HPLC), or a syringe pump. The solvents of the subject matter disclosed herein are pumped via pressure-based pumping methods. Pressure-based pumping produces a flow rate that is laminar, with a parabolic velocity distribution (in a direction perpendicular to the direction to the direction of bulk fluid flow) when the Reynolds Number is generally 400-2000. In a preferred embodiment, the pressure and flow of the hydrodynamic pumping is ‘pulse-free’ to ensure the flow is accurate. Optionally, the pumping mechanism can be feedback controlled such that the flow is measured and the resultant measurement is used in directly to control the pressure applied.

As already noted, it can be advantageous to back-flush reagent solution into the first reservoir after filling of the sample loop. Accordingly, the apparatus according to the subject matter disclosed herein suitably further comprises a back-flush reservoir of the spacer solvent connected through a conduit to the multi-port valve for back-flushing the reaction solution into the first reservoir.

As already noted, the apparatus in certain embodiments comprises an injector for supplying reaction plugs of indefinite length. This injector comprises a second sample loop, wherein said first reservoir, an inlet of said reaction channel, and respective inlet and outlet ends of the first and second sample loops are connected through respective liquid conduits to a multi-port valve to permit substantially continuous injection of said first reaction solvent into the channel.

The apparatus preferably further comprises a source of heat, pressure, microwave radiation, light, or ultrasound for activating a chemical process in the reaction channel, as hereinbefore discussed in relation to the first aspect of the subject matter disclosed herein. Alternatively or additionally a source of cooling for cooling the chemical reaction in the reaction channel may be provided. Alternatively or additionally, the reaction channel contains a region comprising a bed of solid particles, which have a particular functionality on them. The functionality of these particles can make them act as a catalyst for a particular chemical reaction, or it can allow them to act as purifying agents for the reaction and/or the spacer plug. If the solid particles are said to act as a catalyst, sequential reagent plugs can be configured such that they regenerate the catalyst.

The apparatus preferably further comprises one or more detectors for identifying which solvent is present at one or more predetermined positions in one or more of the channels. These detectors function as plug detectors, identifying when a leading edge and/or trailing edge of a plug passes the position of the detector. As such, they have many uses for the control of the flow reactor. Preferably, the plug detector is an optical or infrared detector for detecting differences in refractive index between the solvents. The plug detectors permit controlled operation of the flow reactor, and are especially useful when the length of the reaction plugs and/or of the spacer plugs is not constant.

An especially useful form of plug detector is an optical detector comprising a light (or IR) transmitter such as an LED for transmitting light radially through a translucent side wall of the channel, and a light detector for detecting light scattered from the liquid inside the channel. Typically, the detector will be configured to detect light scattered at about 90 degrees to the incident light, through the translucent side wall of the channel. It has been found that, in order to optimise the output of such a detector with transparent flow reactor tubing, it has been desirable to provide a reflective coating (e.g. silvering) around the outside of the channel tubing opposite the transmitter and detector. A suitable detector is provided under the registered trade mark KEYENCE®.

For example, in certain embodiments, a plug detector is located proximate to an outlet end of the reaction channel, and the apparatus further comprises a valve at the outlet end for selectively directing the flow from the outlet into a first outlet conduit or a second outlet conduit in response to an output of the detector. In this way, the reaction plugs and the spacer plugs are efficiently separated at the outlet of the flow reactor.

In further embodiments, the apparatus comprises at least one said plug detector located proximate to a junction between an inlet channel and the reaction channel, whereby the pumping is operated selectively in response to the output of the plug detector to achieve synchronised passage of reagent plugs past said junction to achieve merging of the reagent plugs at the junction.

In further embodiments, the apparatus comprises at least one said plug detector located near a downstream end (outlet) of the reaction channel, whereby a valve incorporated into the reaction channel may be switched in response to the output of the plug detector such that a small portion of the reaction plug can be diverted to a parallel system for chemical analysis as a representative sample of the whole reaction plug

It will be appreciated that the apparatus according to the subject matter disclosed herein will preferably further comprise an automated control system, wherein at least some of the pumps and valves present in the apparatus are under automated control, and further wherein the output of the control system is dependent on the output of at least one of said plug detectors. In this way the apparatus is operable in fully automatic or semi-automatic fashion.

In certain embodiments, the apparatus further comprises a back-pressure regulator. This allows reactions to be conducted at higher temperatures inside the channel of the reactor. The back-pressure regulator prevents the reaction plugs breaking up at temperatures in excess of 120° C.

It will be appreciated that any optional feature that has been described above in relation to any one aspect of the subject matter disclosed herein may also be applicable to any other aspect of the subject matter disclosed herein.

### BRIEF DESCRIPTION OF THE DRAWINGS

Specific embodiments of the subject matter disclosed herein will now be described in more detail, by way of example, with reference to the accompanying drawings, in which:

FIG. 1 shows a schematic view of a flow channel in the form of a loop with reaction plugs and spacer solvent plugs flowing along the channel in accordance with the subject matter disclosed herein;

FIG. 2 shows a detailed sectional view through a region of the channel of FIG. 1, illustrating the circulation of liquid within the reaction plug;

FIG. 3 shows a schematic plan view of a flow reactor apparatus according to the subject matter disclosed herein;

FIGS. 4(a) and 4(b) show schematic plan views of a plug injection apparatus for use in the apparatus of FIG. 3, with the injection apparatus performing a spacer plug injection in FIG. 4(a) and a reaction plug injection in FIG. 4(b);

FIGS. 5(a) and 5(b) show schematic plan views of two alternative states of a second injector for injection of plugs of indefinite length; and

FIG. 6 shows a schematic transverse cross section through the channel and optical detector at VI-VI in FIG. 3.

### DETAILED DESCRIPTION

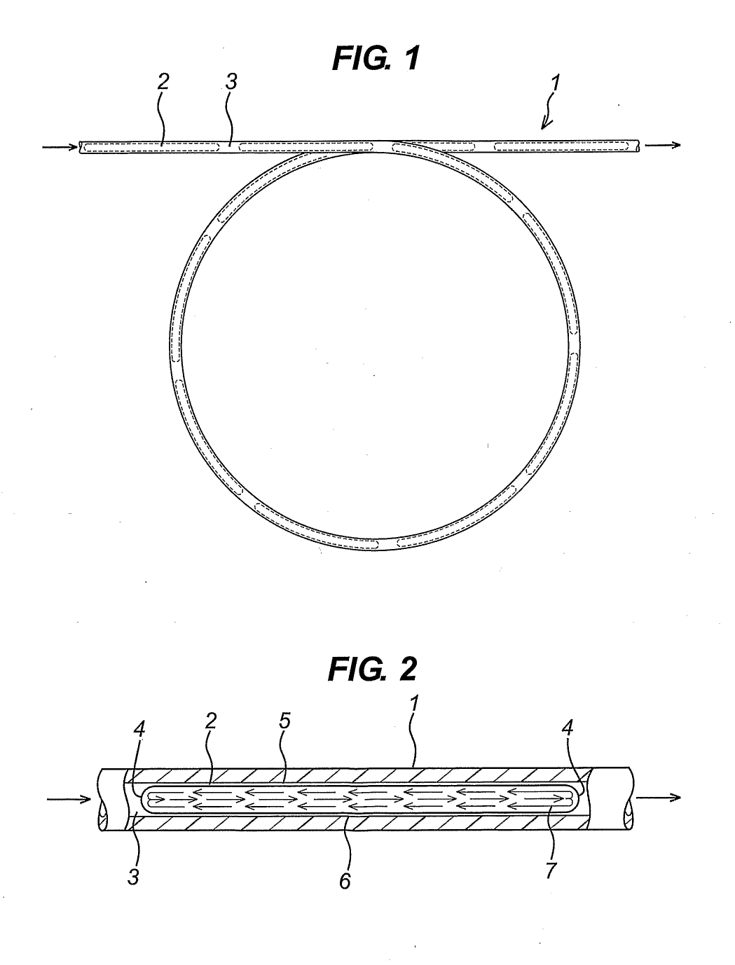

Referring to FIG. 1, there is shown part of a reaction channel being operated in accordance with the subject matter disclosed herein. The reaction channel 1 is an elongated tube of PTFE or PFA having outside diameter 1.5 mm and internal diameter 0.75 mm, in the form of a loop of one or more turns. A plurality of reaction plugs 2 having an aspect ratio greater than 10 are being pumped along the reaction channel 1, separated by short spacer plugs 3.

FIG. 2 shows a more detailed view of the tube 1 and reaction plug 2 of FIG. 1. It can be seen that the reaction plug 2 has a relatively low affinity for the inside surface 5 of the tube 1. As a result, the reaction plug 2 has convex ends 4 at the interfaces with the spacer plugs 3. In contrast, the spacer solvent has relatively high affinity for the inside wall 5 of the tube 1, and wets this wall forming an interfacial layer 6 between the wall and the reaction plug 2 that further reduces adsorption of reagents or products from the reaction plugs onto the walls of the tube 1, helps to reduce dispersion within the reaction plugs 2 and aids transportation of suspended solids within the reaction plug 2 along the tube 1. Arrows 7 in FIG. 2 show the flow-driven circulation of liquid within reaction plug 2 as the plug is propelled along pipe 1. This circulation within plug 2 results in high homogeneity within the reaction plugs, even for plugs having high aspect ratio.

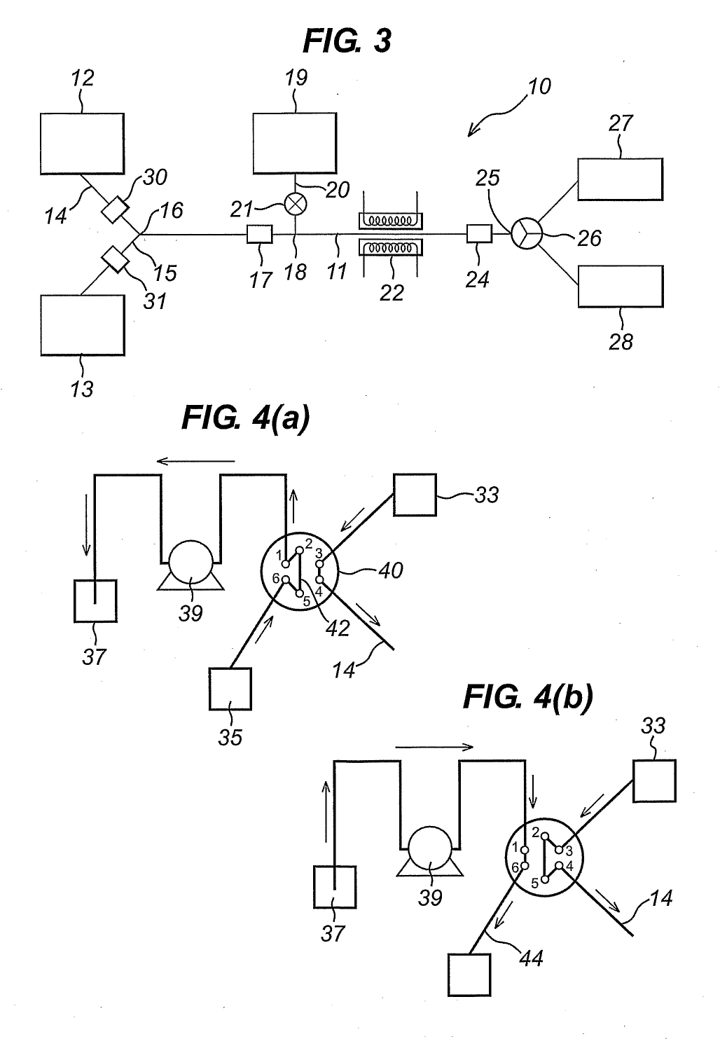

Referring to FIG. 3, the schematic apparatus according to the subject matter disclosed herein 10 comprises a reaction channel 11 similar to that described in relation to FIG. 1. The apparatus further comprises a first reagent injector 12 and a second reagent injector 13. The injectors are adapted to inject respective reagent plugs separated by spacer plugs through respective inlet channels 14, 15 that meet at a junction 16 at the inlet of the reaction channel 11. The respective reagent plugs meet and merge at junction 16. Plug detectors 30, 31 are provided in the inlet lines 14, 15 to ensure synchronised merging of reagent plugs from injectors 12, 13, and to control the reagent injectors, such that subsequent reagent plugs can be formed in the injector as soon as the reagent injectors have been emptied.

The resulting reaction plugs separated by spacer plugs then pass down the reaction channel 11 past plug detector 17, and through second junction 18. A further reagent supply 19 is joined to the reaction channel 11 at said junction 18 through further reagent inlet 20. The injector 19 is actuated in response to the output of plug detector 17 to ensure that the further reagent is injected into channel 11 simultaneously with the passage of a reaction plug past junction 18. The apparatus further comprises an activation zone 22 situated downstream of junction 18 which may contain a heater, microwave source, ultrasound source, cooler, or an area packed with a solid catalyst bed, for activating the reaction plugs to initiate or otherwise control a desired chemical reaction. A further plug detector 24 is located downstream from the activation zone, proximate to the outlet 25 of the reaction channel 11. The outlet 25 of the reaction channel is connected through four-way valve 26 to product reservoir 27 and spacer solvent reservoir 28. The outflow from the reaction channel 11 is switched between these reservoirs by four-way valve 26 in response to the output of plug detector 24. In this way, the reaction products can be substantially separated from the spacer solvent. The four way valve 26 is further connected to a pump that allows the tubing from the four way valve 26 to the product reservoir 27 to be emptied into the product reservoir 27, between sequential reaction plugs.

The various pumps, valves, detectors and injectors are under the control of an automated control system (not shown) to permit automated operation of the flow reactor.

Referring to FIGS. 4(a) and 4(b), there is shown a more detailed schematic view of the injectors 12, 13 of the apparatus of FIG. 3. Each injector comprises a reservoir 33 of spacer solvent, a reservoir 35 of a reagent solution having the respective reagent dispersed therein, and a further reservoir 37 of spacer solvent. The reagent solvents and spacer solvents are as hereinbefore described in relation to the reaction plugs and spacer plugs, respectively. A Milligat M6 pump 39 is provided in the line to spacer reservoir 37. The reservoirs 33, 35 and 37 are connected through suitable conduits respectively to Port #3, Port #6 and Port #1 of a six-port valve 40. Port #4 of the valve is connected to the inlet channel 14 (or 15) of the apparatus. A sample loop 42 is connected across Port #2 and Port #5 of the six-port valve.

In the configuration shown in FIG. 4 (a), the sample loop 42 is filled with the first reagent by connecting Ports 1-2-5-6 in series and activating pump 39 to draw the first reagent solution into the loop. Simultaneously, Ports #3 and #4 are connected in series and a pump (not shown) is activated to continuously pump spacer solvent from reservoir 33 into the inlet conduit 14 of the apparatus. Upon completion of this step, the six-port valve is switched so that to the configuration shown in FIG. 4 (b), in which Ports 3-2-5-4 are connected in series, and ports 1-6 are separately connected in series. A pump (not shown) continuously pumping spacer solvent from reservoir 33 now flows into Port #3 to displace the plug of first reagent solution into inlet 14 of the apparatus. Meanwhile, the flow of pump 39 to Port #1 is reversed to back-flush line 44 with fresh spacer from reservoir 37 to collect exactly the volume of first reagent contained in line 44, into reagent reservoir 35. By automating steps 4(a) and 4(b) it is possible to inject reagent plugs into inlet line 14 separated by spacer plugs, in a fully controlled fashion.

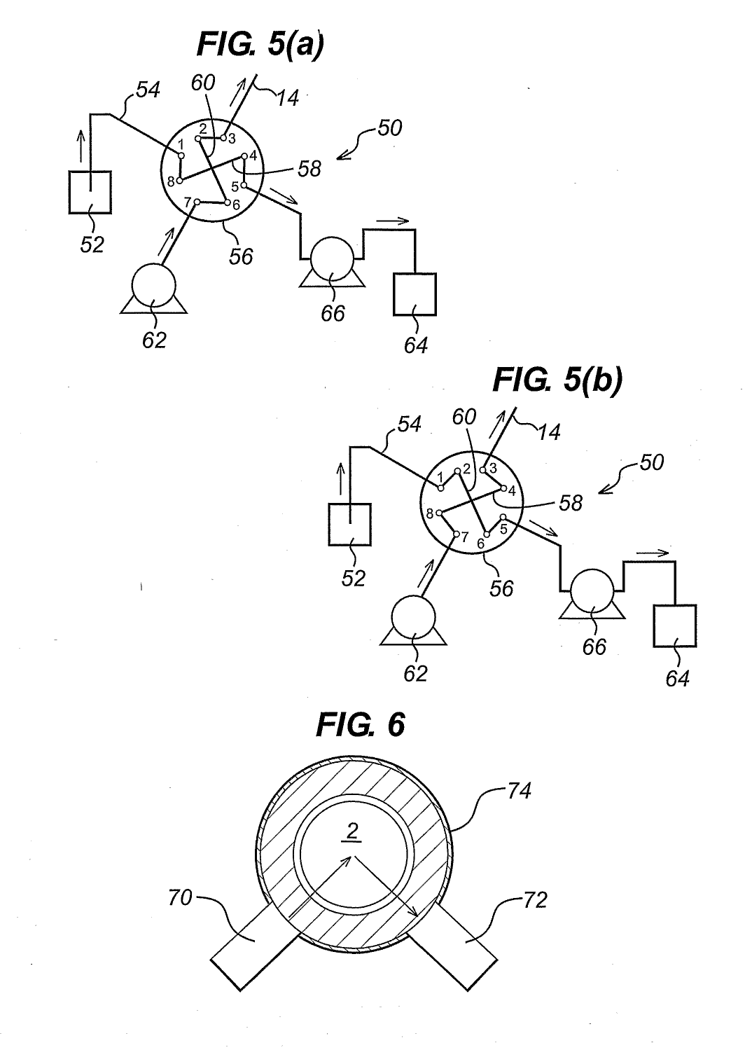

A drawback of the injector shown in FIGS. 4(a) and 4(b) is that the maximum size of the reagent plug that can be injected is limited by the size of the sample loop 42. This drawback can be overcome by use of the quasi-continuous injector shown in FIGS. 5(a) and 5(b). The quasi-continuous injector 50 comprises a reservoir 52 of the reagent solution connected through line 54 to Port #1 of an eight-port valve 56. Two sample loops 58, 60 are connected across ports #2 and #6, and ports #4 and #8, respectively. A first pump 62 is connected to port #7 of the eight-port valve 56, and a second pump 66 is connected to port #5 to pump liquid from that port into a spacer reservoir 64. The inlet channel 14 of the apparatus in connected to port #3 of the eight-port valve.

In the initial state shown in FIG. 5(a), ports 1-8-4-5 are connected in series, and loop 58 is filled with reagent solution from reservoir 52 by pump 66. At the same time, ports 3-2-6-7 are connected in series, and pump 62 expels the reagent from loop 60 into inlet channel 14. Once the steps are completed, the configuration of the eight-port valve is switched so as to connect to ports 1-2-6-5 in series and ports 3-4-8-7 in series. Sample loop 58 is then emptied into the inlet channel 14 while sample loop 60 is refilled. In this way, a continuous reagent plug of any size can be produced.

Referring to FIG. 6, a cross-section is shown through an optical plug detector attached to the translucent reaction channel 11. The plug detector is a Keyence FU-95Z sensor. It comprises a light transmitter 70, such as an LED, and a light sensor 72 positioned to detect light of the transmitter frequency scattered at 90° to the angle of transmission. An outer surface 74 of the reaction tube 11 is silvered to enhance backscattering contrast. It has been found that the measured amplitude of scattered light is strongly dependent on the presence or absence of a reaction plug 2 in the tube. The measured intensity of scattered light is substantially constant for a given solvent, but changes abruptly when the solvent inside the tube changes. The output of the detector thus resembles a square wave as successive plugs pass down the channel.

Several reactions have been carried out using the method and apparatus of the subject matter disclosed herein including oxidations, reductions, alkylations, aromatic substitutions and amidations. The results achieved were comparable to those of traditional batch methods. Certain of these exemplary reactions will now be described further, by way of example.

### EXAMPLE 1

### Aromatic Substitution Reaction

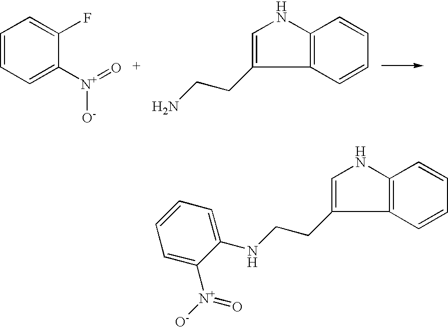

A 0.67M solution of fluoro nitro benzene in DMF was produced, and placed in reagent reservoir 1. A 0.67M solution of tryptamine in DMF was produced and placed in reagent reservoir 2.

The apparatus comprised of 2 reagent injector systems, each containing a 2.7 ml injection loop as in FIG. 4a, and a reactor of volume 2.7 ml. All tubing in the system was PFA, of id 0.75 mm. Spacer solvent reservoirs contained PFMD. The reactor was of a configuration that allowed it to be heated electrically to a defined and controlled temperature.

Equal volumes of reagent 1 and reagent 2 were combined to form a reaction plug, sequential plugs were formed of increasing volume, reaction plugs were flowed through the reactor at a flow rate of 0.3 ml/min, and a temperature of 80° C., residence time of the reaction plug within the reactor was 9 mins. The reaction plug was collected at the outlet of the reactor, and quenched immediately into water. On completion of collecting the whole plug, a representative sample was taken and diluted with methanol for analysis by LCMS. Relative peak areas of reagent peaks and product peaks were determined as indicative of the progress of the reaction.

| | Volume | | | | | | | LCMS |
|---|---|---|---|---|---|---|---|---|
| | of | | | | | LCMS peak | LCMS peak | peak |
| Reaction | reaction | | Plug | | Aspect | area of | area of | area of |
| plug No. | plug | | length | | ratio | reagent 1 | reagent 2 | product |
| 1 | 0.04 | ml | 9.0 | cm | 120 | 19 | 16 | 63 |
| 2 | 0.2 | ml | 45.2 | cm | 603 | 18 | 17 | 62 |
| 3 | 0.5 | ml | 113 | cm | 1507 | 16 | 18 | 63 |
| 4 | 1.0 | ml | 226 | cm | 3015 | 14 | 20 | 62 |
| 5 | 2.0 | ml | 452 | cm | 6030 | 17 | 20 | 60 |
| 6 | 5.0 | ml | 1130 | cm | 15067 | 18 | 20 | 59 |

In a subsequent experiment, using the same reagent reservoirs containing the same reagents as described above, a single reaction plug was formed of size 0.5 ml (with an aspect ratio of 1507), consisting of equal volumes of reagent 1 and reagent 2, and flowed through the same reactor at a flow rate of 0.3 ml/min, and a temperature of 80° C. The residence time of the reaction plug in the reactor was 9 mins. The reaction plug was sampled along its length as it exited from the reactor, by collecting a single drop every 10 seconds as it emerged, and quenching the drop directly into a mixture of methanol and water. The remainder of the plug was collected and quenched immediately into water. Each diluted drop, and a representative sample from the rest of the plug was analysed by LCMS, relative peak areas of reagent peaks and product peaks were determined as indicative of the progress of the reaction.

| | | | LCMS peak | LCMS peak | LCMS peak |
|---|---|---|---|---|---|
| Sample | Sampling | | area of | area of | area of |
| No. | time | | reagent 1 | reagent 2 | product |
| 1 | 0 | sec | 16 | 21 | 61 |
| 2 | 10 | sec | 17 | 20 | 60 |
| 3 | 20 | sec | 16 | 22 | 60 |
| 4 | 30 | sec | 14 | 19 | 66 |
| 5 | 40 | sec | 16 | 21 | 61 |
| 6 | 50 | sec | 16 | 20 | 62 |
| 7 | 60 | sec | 16 | 21 | 60 |
| 8 | 70 | sec | 27 | 13 | 60 |

| | | | | |
|---|---|---|---|---|
| 9 | Combined | 17 | 20 | 61 |
| | plug | | | |

The results of these experiments indicate the uniformity in the course of a reaction along the length of a given plug, with an aspect ratio of significantly greater than about 10, and the uniformity in the course of a reaction from increasingly large plugs, with aspect ratios from 120 to 15000.

### EXAMPLE 2

### Aromatic Substitution Using Microwave Activation

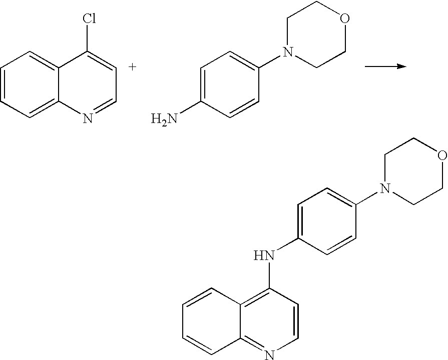

A 0.4 M solution of 4-chloroquinoline in DMSO was produced, and placed in reagent reservoir 1. A 0.4 M solution of 4-morpholinoaniline in DMSO was produced and placed in reagent reservoir 2.

The apparatus comprised of 2 reagent injector systems, each containing a 2.7 ml injection loop as in FIG. 4a, and a reactor of volume 2.7 ml. All tubing in the system was PFA, of id 0.75 mm. Spacer solvent reservoirs contained PFMD. The reactor was of a configuration that allowed it to be activated by microwaves at a defined and controlled power, and the temperature moderated by the use of a flow of compressed air through the reactor cavity.

Equal volumes of reagent 1 and reagent 2 were combined to form a reaction plug, sequential plugs were formed of increasing volume, reaction plugs were flowed through the reactor at a flow rate of 0.54 ml/min, with a microwave power of 120 W. Residence time of the reaction plug within the reactor was 5 mins. The reaction plugs were collected at the outlet of the reactor, and quenched directly into water. A representative sample was taken from each plug and diluted with methanol for analysis by LCMS. Peak area of product peaks relative to reagent peaks were determined as indicative of the yield of the product formed.

| | Volume of | | | |
|---|---|---|---|---|
| Reaction | reaction | Plug length | | |
| plug No | plug (mls) | (cm) | Aspect ratio | % yield of product |
| 1 | 1.0 | 226 | 3013 | 67 |
| 2 | 1.2 | 271 | 3615 | 69 |
| 3 | 1.5 | 339 | 4520 | 72 |
| 4 | 2.0 | 452 | 6027 | 70 |
| 5 | 4.0 | 904 | 12054 | 73 |

### EXAMPLE 3

### Sulphonamide Formation

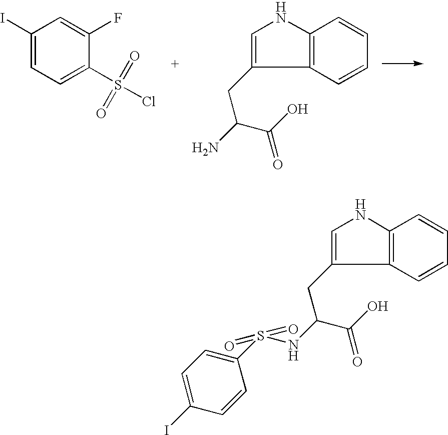

A 0.2 M solution of pipsyl chloride in dioxan was produced, and placed in reagent reservoir 1. A 0.24 M solution of tryptophan and sodium hydroxide in a 1.5:3.5 mixture of water:dioxan was produced and placed in reagent reservoir 2.

The apparatus comprised of 2 reagent injector systems, each containing 2×1 ml injection loops as in FIG. 5a, and a reactor of volume 6.7 ml. All tubing in the system was PFA, of id 0.75 mm. Spacer solvent reservoirs contained PFMD.

Equal volumes of reagent 1 and reagent 2 were combined to form a reaction plug, sequential plugs were formed of increasing volume, reaction plugs were flowed through the reactor at a flow rate of 1 ml/min, residence time of the reaction plug within the reactor was 6.7 mins. The reaction plug was collected at the outlet of the reactor, and quenched immediately into 0.5 M HCl. On completion of collecting the whole plug, the solution was extracted with DCM, and the extract evaporated to dryness. The product thus obtained was analysed for purity, by LqMS, and isolated yield determined by weight.

| | Vol. of | Plug | | | | | |
|---|---|---|---|---|---|---|---|
| Reaction | reaction | length | Aspect | Purity by | | | % |
| plug No | plug (mls) | (cm) | ratio | LCMS | Yield | | Yield |
| 1 | 2 | 452 | 6027 | 94.6% | 94 | mg | 83.0 |
| 2 | 10 | 2260 | 30135 | 94.6% | 394 | mg | 84.0 |
| 3 | 150 | 33900 | 452025 | 92.2% | 6.10 | g | 84.6 |

The above embodiments have been described by way of example only. Many other embodiments falling within the scope of the accompanying claims will be apparent to the skilled reader.

It will be understood that various details of the subject matter can be changed without departing from the scope of the subject matter. Furthermore, the foregoing description is for the purpose of illustration only, and not for the purpose of limitation.

What is claimed is:

1. A method of conducting a chemical reaction in a flow reactor, said method comprising the steps of:
pumping at least one liquid reaction plug bounded at both ends by liquid spacer plugs along a reaction channel of said reactor; and
conducting said chemical reaction in said reaction plug inside said reaction channel,
wherein the liquid reaction plug comprises one or more reagents dispersed in a reaction solvent, the liquid spacer plugs are immiscible in the reaction solvent, and
the reagents are substantially insoluble in the spacer plugs; and
wherein the aspect ratio of the at least one reaction plug is at least about 10.

2. The method of claim 1, wherein the flow reactor comprises first and second inlet channels that meet at an inlet of the reaction channel, and the method comprises:
pumping a first reagent liquid plug containing a first reagent and bounded at both ends by liquid spacer plugs along the first inlet channel;
pumping a second reagent liquid plug containing a second reagent and bounded at both ends by liquid spacer plugs along the second inlet channel,
said pumping being carried out such that said first reagent plug mixes with said second reagent plug in said reaction channel to form said reaction plug containing a reaction mixture.

3. The method of claim 1, wherein the flow reactor comprises a further inlet channel in fluid communication with the reaction channel, and the method comprises:
pumping a further reagent liquid plug containing a further reagent and bounded at both ends by liquid spacer plugs along the further inlet channel,
said pumping being carried out such that said further reagent plug mixes with said reaction plug in said reaction channel.

4. The method of claim 1, wherein said step of conducting comprises application of heat, cooling, pressure, microwave radiation, light, or ultrasound to said reaction plug, or passage of the reaction plug through a packed bed of activated material.

5. The method of claim 1, further comprising the step of monitoring the reaction taking place inside the channel by means of a detector.

6. The method of claim 1, further comprising the step of monitoring the passage of said plugs through the reaction channel and/or an inlet channel by means of a plug detector.

7. The method of claim 6, wherein a plug detector is located proximate to an outlet of the reaction channel, and the method further comprises switching the outlet of said channel between a reaction mixture collector and a spacer solvent collector in response to an output of said plug detector.

8. The method of claim 6, wherein a plug detector is located proximate to a junction between an inlet channel and the reaction channel, and injection of a reagent plug into the reaction channel is synchronised with passage of a reaction plug past said junction.

9. The method of claim 6, wherein a plug detector is operatively associated with a sampling valve, and the method further comprises synchronises the switching of the sampling valve with passage of a reaction plug, such that a small portion of the reaction plug can be removed through said sampling valve for analysis.

10. The method of claim 1, wherein the spacer plugs comprise one or more fluorinated solvents.

11. The method of claim 1, wherein the reaction solvents comprise one or more organic solvents selected from the group consisting of dimethylformamide (DMF), dimethylsulfoxide (DMSO), N-methyl pyrrolidinone (NMP), acetonitrile, dichloromethane (DCM), chloroform, ethyl acetate, ethanol, methanol, tetrahydrofuran (THF), diethyl ether, and toluene.

12. The method of claim 1, wherein the liquid flow rate in said reaction channel is from about 0.05 ml/min to about 2 ml/min.

13. The method of claim 1, wherein the aspect ratio of said reaction plug is at least about 20.

14. The method of claim 1, wherein the volume of said reaction plugs is at least about 0.1 ml.

15. The method of claim 1, wherein the ratio by volume of said reaction plugs to said spacer plugs is from about 2:1 to about 5000:1.

16. The method of claim 1, further comprising the step of embedding a wash plug of a wash solvent that is immiscible in the spacer solvent into at least one of the spacer solvent plugs.

17. The method of claim 1, wherein at least one of the reagent plugs is formed by the steps of:
filling a sample loop with the reagent solution;
pumping a spacer solvent into an inlet channel of the flow reactor; followed by displacing the reagent solution from the sample loop into the said inlet channel by pumping a spacer solvent into said sample loop.

18. The method of claim 17, wherein the sample loop is filled through a reagent inlet line from a reagent solution reservoir, and the method further comprises back-flushing said reagent inlet line with further spacer solvent after said step of filling.

19. The method of claim 1, wherein at least one of the reagent plugs is formed by the steps of:
filling a first sample loop with the reaction solution; pumping the reaction solution from the first sample loop into an inlet channel while filling a second sample loop with the reaction solution; followed by pumping the reaction solution from the second sample loop into the inlet channel while refilling the first sample loop with the reaction solution.

20. A flow reactor apparatus comprising:
a reaction channel having a cross sectional area of at least about 0.05 mm² and length at least about 50 cm;
a first reservoir for a reaction solution containing a reagent;
a sample loop for containing a sufficient quantity of said reaction solution to provide a reaction plug in said flow channel having an aspect ratio of at least about 10;
a second reservoir for a spacer solvent that is immiscible in the reaction solution; and
at least one pump for pumping said reaction plug bounded by plugs of said spacer solvent through said channel.

21. An apparatus according to claim 20, wherein an inside surface of the reaction channel is wetted by the spacer solvent.

22. An apparatus according to claim 20, wherein the inside surface of the reaction channel is manufactured from a polytetrafluoroethylene (PTFE) or a perfluoroalkoxy resin (PFA).

23. An apparatus according to claim 20, wherein the cross-sectional area of the reaction channel is from about 0.1 mm² to about 4 mm², and the length of the reaction channel is from about 1 m to about 50 m.

24. An apparatus according to claim 20, comprising a plurality of inlet channels in liquid communication with the reaction channel for introducing a plurality of different reagent plugs into the reaction channel for mixing in the reaction channel to form said reaction plug.

25. An apparatus according to claim 20, wherein said first and second reservoirs, an inlet of said reaction channel, and first and second ends of the sample loop are connected through respective liquid conduits to a multi-port valve.

26. An apparatus according to claim 25, further comprising a back-flush reservoir of said spacer solvent connected through a conduit to said multi-port valve for back-flushing said first reagent into said first reservoir.

27. An apparatus according to claim 20, further comprising a second sample loop, wherein said first reservoir, an inlet of said reaction channel, and respective first and second ends of the first and second sample loops are connected through respective liquid conduits to a multi-port valve to permit substantially continuous injection of a reagent solution into the inlet.

28. An apparatus according to claim 20, further comprising a source of heat, cooling, pressure, microwave radiation, light, or ultrasound for activating a chemical process in said reaction plugs inside said reaction channel, or a packed bed of activated material such as a catalyst.

29. An apparatus according to claim 20, further comprising at least one detector for identifying which solvent is present at a predetermined position in an inlet channel and/or a reaction channel and thereby functioning as a plug detector.

30. An apparatus according to claim 29, wherein said detector is an optical detector comprising a light transmitter for transmitting light radially through a translucent side wall of the channel, and a light detector for detecting light scattered from the liquid inside the channel.

31. An apparatus according to claim 29, wherein one said plug detector is located proximate to a downstream end of the reaction channel, and an outlet of the reaction channel is directed through a three-way valve for selectively directing the flow from said outlet into a product solution reservoir or a spacer solvent reservoir in response to the output from said detector.

32. An apparatus according to claim 29, wherein at least one said plug detector is located proximate to a junction between an inlet channel and the reaction channel, whereby the pumping is operated selectively in response to the output of the plug detector to achieve synchronised passage of reagent plugs past said junction to achieve merging of said reagent plugs at said junction.

33. An apparatus according to claim 29, wherein at least one said plug detector is operatively associated with a sampling valve containing, whereby the sampling valve is synchronised in response to the output of the plug detector such that a small portion of a passing reaction plug can be removed by the sampling valve for analysis.

34. An apparatus according to claim 29, further comprising an automated control system, wherein at least some of the pumps and valves and present in said apparatus are under automated control, and further wherein the output of said control system is dependent on the output of at least one of said plug detectors.

35. The method according to claim 10, wherein the one or more fluorinated solvent is one or more perfluorinated solvents.

36. The method according to claim 35, wherein the one or more perfluorinated solvent is one or more perfluoroalkanes.

37. The method according to claim 36, wherein the one or more perfluoroalkanes is selected from the group consisting of perfluorodecalin (PFD) and perfluoromethyldecalin (PFMD).

38. The method according to claim 12, wherein the liquid flow rate in said reaction channel is from about 0.1 ml/min to about 1 ml/min.

39. The method according to claim 13, wherein the aspect ratio of said reaction plug is at least about 50

40. The method according to claim 39, wherein the aspect ratio of said reaction plug is at least about 100.

41. The method according to claim 14, wherein the volume of said reaction plugs is at least about 1 ml.

42. The method according to claim 41, wherein the volume of said reaction plugs is at least about 5 ml.

43. The method according to claim 15, wherein the ratio by volume of said reaction plugs to said spacer plugs is from about 10:1 to about 1000:1.
